(19) United States
(12) Patent Application Publication
(10) Pub. No.: US 2007/0042251 A1
(43) Pub. Date: Feb. 22, 2007

(54) ELECTROCHEMICAL CELL WITH MEMBRANE-ELECTRODE-ASSEMBLY SUPPORT

(75) Inventor: Jacob Friedman, Storrs, CT (US)

Correspondence Address: CANTOR COLBURN, LLP - PROTON, 55 GRIFFIN ROAD SOUTH, BLOOMFIELD, CT, 06002, US

(73) Assignee: PROTON ENERGY SYSTEMS, INC., Wallingford, CT (US)

(21) Appl. No.: 11/161,796

(22) Filed: Aug. 17, 2005

(51) Int. Cl. H01M 8/02; H01M 8/10

(52) U.S. Cl. 429/34; 29/623.4; 429/30

(57) ABSTRACT

An electrochemical cell having a membrane-electrode-assembly (MEA), a cell separator plate disposed on a side of the MEA and defining a flow field therebetween, a MEA support layer disposed adjacent the MEA within the flow field, and a MEA support layer stiffener disposed adjacent the support layer on a side opposite that of the MEA is disclosed. The support layer and stiffener are porous and electrically conductive, and the stiffener is mechanically and electrically bonded to the cell separator plate.

### BACKGROUND OF INVENTION

The present disclosure relates generally to electrochemical cells, and particularly to electrochemical cells having a membrane-electrode-assembly (MEA) support.

Electrochemical cells are energy conversion devices that may be classified as electrolysis cells or fuel cells. A proton exchange membrane electrolysis cell can function as a hydrogen generator by electrolytically decomposing water to produce hydrogen and oxygen gas, and can function as a fuel cell by electrochemically reacting hydrogen with oxygen to generate electricity. Referring to FIG. 1, which is a partial section of a typical anode feed electrolysis cell 100, process water 102 is fed into cell 100 on the side of an oxygen electrode (anode) 116 to form oxygen gas 104, electrons, and hydrogen ions (protons) 106. The reaction is facilitated by the positive terminal of a power source 120 electrically connected to anode 116 and the negative terminal of power source 120 connected to a hydrogen electrode (cathode) 114. The oxygen gas 104 and a portion of the process water 108 exits cell 100, while protons 106 and water 110 migrate across a proton exchange membrane 118 to cathode 114 where hydrogen gas 112 is formed.

Another typical water electrolysis cell using the same configuration as is shown in FIG. 1 is a cathode feed cell, wherein process water is fed on the side of the hydrogen electrode. A portion of the water migrates from the cathode across the membrane to the anode where hydrogen ions and oxygen gas are formed due to the reaction facilitated by connection with a power source across the anode and cathode. A portion of the process water exits the cell at the cathode side without passing through the membrane.

A typical fuel cell uses the same general configuration as is shown in FIG. 1. Hydrogen gas is introduced to the hydrogen electrode (the anode in fuel cells), while oxygen, or an oxygen-containing gas such as air, is introduced to the oxygen electrode (the cathode in fuel cells). Water can also be introduced with the feed gas. The hydrogen gas for fuel cell operation can originate from a pure hydrogen source, hydrocarbon, methanol, or any other hydrogen source that supplies hydrogen at a purity suitable for fuel cell operation (i.e., a purity that does not poison the catatlyst or interfere with cell operation). Hydrogen gas electrochemically reacts at the anode to produce protons and electrons, wherein the electrons flow from the anode through an electrically connected external load, and the protons migrate through the membrane to the cathode. At the cathode, the protons and electrons react with oxygen to form water, which additionally includes any feed water that is dragged through the membrane to the cathode. The electrical potential across the anode and the cathode can be exploited to power an external load.

In other embodiments, one or more electrochemical cells may be used within a system to both electrolyze water to produce hydrogen and oxygen, and to produce electricity by converting hydrogen and oxygen back into water as needed. Such systems are commonly referred to as regenerative fuel cell systems.

Electrochemical cell systems typically include a number of individual cells arranged in a stack, with the working fluids directed through the cells via input and output conduits formed within the stack structure. The cells within the stack are sequentially arranged, each including a cathode, a proton exchange membrane (PEM), and an anode. The cathode and anode may be separate layers or may be integrally arranged with the membrane. Each cathode/membrane/anode assembly (hereinafter “membrane electrode assembly”, or “MEA”) typically has a first flow field in fluid communication with the cathode and a second flow field in fluid communication with the anode. The MEA may furthermore be supported on both sides by screen packs or bipolar plates disposed within flow fields. Screen packs or bipolar plates may facilitate fluid movement to and from the MEA, membrane hydration, and may also provide mechanical support for the MEA.

In order to maintain intimate contact between cell components under a variety of operational conditions and over long time periods, uniform compression is applied to the cell components. Pressure pads or other compression means are often employed to provide even compressive force from within the electrochemical cell.

While existing internal components are suitable for their intended purposes, there still remains a need for improvement, particularly regarding cell efficiency at lower cost, weight and size. Accordingly, a need exists for improved internal cell components of an electrochemical cell that can operate at sustained high pressures and low resistivities, while offering a low profile configuration at a low cost.

### BRIEF DESCRIPTION OF THE INVENTION

An embodiment of the invention includes an electrochemical cell having a membrane-electrode-assembly (MEA), a cell separator plate disposed on a side of the MEA and defining a flow field therebetween, a MEA support layer disposed adjacent the MEA within the flow field, and a MEA support layer stiffener disposed adjacent the support layer on a side opposite that of the MEA. The support layer and stiffener are porous and electrically conductive, and the stiffener is mechanically and electrically bonded to the cell separator plate.

Another embodiment of the invention includes a method of stiffening a support layer for a membrane-electrode-assembly (MEA) of an electrochemical cell. A cell separator plate is made available for assembly within the cell, and is configured for disposition on a side of the MEA to define a flow field therebetween. A porous and electrically conductive MEA support layer is made available for assembly within the cell, and is configured for disposition adjacent the MEA within the flow field. A porous and electrically conductive MEA support layer stiffener is made available for assembly within the cell, and is configured for disposition adjacent the support layer on a side opposite that of the MEA. The stiffener is mechanically and electrically bonded to the cell separator plate.

Yet another embodiment of the invention includes an electrochemical cell having a membrane-electrode-assembly (MEA), a cell separator plate disposed on a side of the MEA and defining a flow field therebetween, a MEA support layer disposed adjacent the MEA within the flow field, and a MEA support layer stiffener disposed adjacent the support layer on a side opposite that of the MEA. The support layer is porous and electrically conductive. The stiffener is composed of a plurality of perforated electrically conductive layers mechanically and electrically bonded together and configured to allow three-dimensional fluid flow. The stiffener is mechanically and electrically bonded to the cell separator plate. The bonded stiffener and cell separator plate are absent metallic plating on their adjoining surfaces.

### BRIEF DESCRIPTION OF THE DRAWINGS

Referring now to the figures wherein like elements are numbered alike:

FIG. 1 depicts a schematic diagram of a partial electrochemical cell showing an electrochemical reaction for use in accordance with an embodiment of the invention;

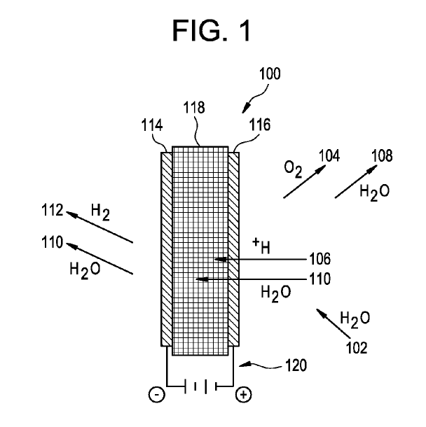

FIG. 2 depicts an exploded assembly isometric view of an exemplary electrochemical cell for use in accordance with an embodiment of the invention;

FIG. 3 depicts an expanded schematic diagram of an electrochemical cell in accordance with an embodiment of the invention and arranged in a manner similar to the cell depicted in FIG. 2;

FIG. 4 depicts an alternative embodiment to the electrochemical cell of FIG. 3, also in accordance with an embodiment of the invention;

FIGS. 5-8 depict alternative embodiments of a flow field member in accordance with embodiments of the invention;

FIG. 9 depicts in exploded assembly view another alternative embodiment of a flow field member in accordance with an embodiment of the invention; and

FIG. 10 depicts in isometric view one side of a bipolar plate for use in accordance with an embodiment of the invention.

### DETAILED DESCRIPTION OF THE INVENTION

Disclosed herein are novel embodiments for an electrochemical cell having electrically conductive, elastically compressible and hydrogen compatible components, such as flow fields and MEA supports for example, strategically disposed within the cell.

Although the disclosure herein is described in relation to a proton exchange membrane (PEM) electrochemical cell employing hydrogen, oxygen, and water, other types of electrochemical cells and/or electrolytes and/or reactants may be used in accordance with an embodiment of the invention and the teachings disclosed herein. Upon the application of different reactants and/or different electrolytes, the flows and reactions are understood to change accordingly, as is commonly understood in relation to that particular type of electrochemical cell.

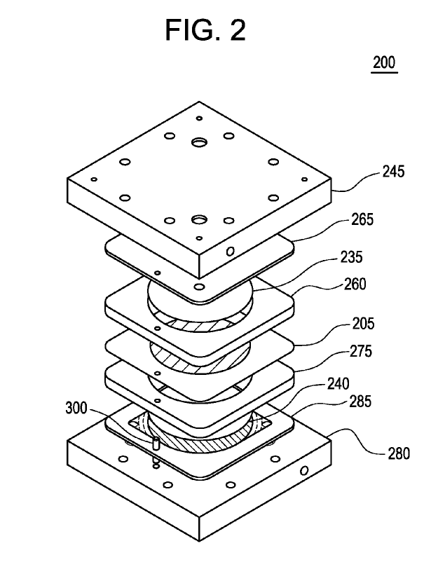

Referring to FIG. 2, an electrochemical cell (cell) 200 suitable for operation as an anode feed electrolysis cell, cathode feed electrolysis cell, fuel cell, or regenerative fuel cell is depicted in an exploded assembly isometric view. Thus, while the discussion below is directed to an anode feed electrolysis cell, cathode feed electrolysis cells, fuel cells, and regenerative fuel cells are also contemplated. Cell 200 is typically one of a plurality of cells employed in a cell stack as part of an electrochemical cell system. When cell 200 is used as an electrolysis cell, power inputs are generally between about 1.48 volts and about 3.0 volts, with current densities between about 50 A/ft² (amperes per square foot) and about 4,000 A/ft². When used as a fuel cells power outputs range between about 0.4 volts and about 1 volt, and between about 0.1 A/ft² and about 10,000 A/ft². The number of cells within the stack, and the dimensions of the individual cells is scalable to the cell power output and/or gas output requirements. Accordingly, application of electrochemical cell 200 may involve a plurality of cells 200 arranged electrically either in series or parallel depending on the application. An alignment pin 300 may be used to maintain the alignment of the components of cell 200.

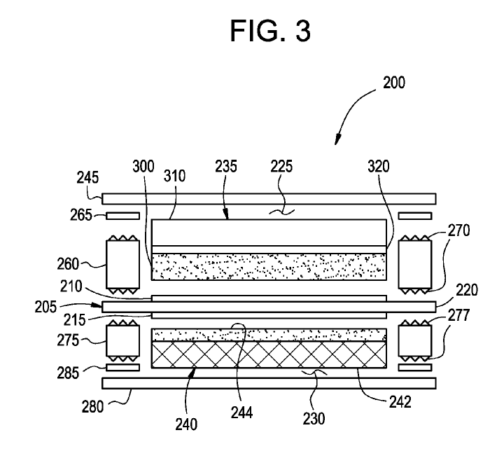

Cells may be operated at a variety of pressures, such as up to or exceeding about 100 psi, up to or exceeding about 500 psi, up to or exceeding about 2500 psi, or even up to or exceeding about 10,000 psi, for example. In an embodiment, cell 200 includes a membrane-electrode-assembly (MEA) 205 having a first electrode (e.g., cathode) 210 and a second electrode (e.g., anode) 215 disposed on opposite sides of a proton exchange membrane (membrane) 220, best seen by now referring to FIG. 3. Exemplary flow fields 225, 230, which are in fluid communication with electrodes 210 and 215, respectively, are defined generally by the regions proximate to, and bounded on at least one side by, each electrode 210 and 215 respectively. A flow field member 235 may be disposed within flow field 225 between electrode 210 and a cell separator plate 245. A frame 260 generally surrounds flow field 225 and an optional gasket 265 may be disposed between frame 260 and cell separator plate 245 generally for enhancing the seal within the reaction chamber defined on one side of cell 200 by frame 260, cell separator plate 245 and electrode 210. Sealing features 270 may be employed on frame 260 for enhanced sealing.

Another flow field member 240 may be disposed in flow field 230. A frame 275 generally surrounds flow field member 240, a cell separator plate 280 is disposed adjacent flow field member 240 opposite oxygen electrode 215, and a gasket 285 is disposed between frame 275 and cell separator plate 280, generally for enhancing the seal within the reaction chamber defined by frame 275, cell separator plate 280, and the oxygen side of membrane 220. Sealing features 277 may be employed on frame 275 for enhanced sealing.

The cell components, particularly cell separator plates (also referred to as manifolds) 245, 280, frames 260, 275, and gaskets 265, 285 may be formed with suitable manifolds or other conduits for fluid flow.

In an embodiment having multiple cells 200 stacked on top of each other, cell separator plates may be bipolar plates, which will be discussed further below.

In an embodiment, membrane 220 comprises electrolytes that are preferably solids or gels under the operating conditions of the electrochemical cell. Useful materials include proton conducting ionomers and ion exchange resins. Useful proton conducting ionomers include complexes comprising an alkali metal salt, alkali earth metal salt, a protonic acid, or a protonic acid salt. Useful complex-forming reagents include alkali metal salts, alkaline metal earth salts, and protonic acids and protonic acid salts. Counter-ions useful in the above salts include halogen ion, perchloric ion, thiocyanate ion, trifluoromethane sulfonic ion, borofluoric ion, and the like. Representative examples of such salts include, but are not limited to, lithium fluoride, sodium iodide, lithium iodide, lithium perchlorate, sodium thiocyanate, lithium trifluoromethane sulfonate, lithium borofluoride, lithium hexafluorophosphate, phosphoric acid, sulfuric acid, trifluoromethane sulfonic acid, and the like. The alkali metal salt, alkali earth metal salt, protonic acid, or protonic acid salt is complexed with one or more polar polymers such as a polyether, polyester, or polyimide, or with a network or cross-linked polymer containing the above polar polymer as a segment. Useful polyethers include polyoxyalkylenes, such as polyethylene glycol, polyethylene glycol monoether, and polyethylene glycol diether; copolymers of at least one of these polyethers, such as poly(oxyethylene-co-oxypropylene) glycol, poly(oxyethylene-co-oxypropylene) glycol monoether, and poly(oxyethylene-co-oxypropylene) glycol diether; condensation products of ethylenediamine with the above polyoxyalkylenes; and esters, such as phosphoric acid esters, aliphatic carboxylic acid esters or aromatic carboxylic acid esters of the above polyoxyalkylenes. Copolymers of, e.g., polyethylene glycol with dialkylsiloxanes, maleic anhydride, or polyethylene glycol monoethyl ether with methacrylic acid are known in the art to exhibit sufficient ionic conductivity to be useful.

Ion-exchange resins useful as proton conducting materials include hydrocarbon- and fluorocarbon-type resins. Hydrocarbon-type ion-exchange resins include phenolic resins, condensation resins such as phenol-formaldehyde, polystyrene, styrene-divinyl benzene copolymers, styrene-butadiene copolymers, styrene-divinylbenzene-vinylchloride terpolymers, and the like, that are imbued with cation-exchange ability by sulfonation, or are imbued with anion-exchange ability by chloromethylation followed by conversion to the corresponding quaternary amine.

Fluorocarbon-type ion-exchange resins can include hydrates of tetrafluoroethylene-perfluorosulfonyl ethoxyvinyl ether or tetrafluoroethylene-hydroxylated (perfluoro vinyl ether) copolymers. When oxidation and/or acid resistance is desirable, for instance, at the cathode of a fuel cell, fluorocarbon-type resins having sulfonic, carboxylic and/or phosphoric acid functionality are preferred. Fluorocarbon-type resins typically exhibit excellent resistance to oxidation by halogen, strong acids and bases. One family of fluorocarbon-type resins having sulfonic acid group functionality is NAFION™ resins (commercially available from E. I. du Pont de Nemours and Company, Wilmington, Del.).

Electrodes 210 and 215 comprise a catalyst suitable for performing the needed electrochemical reaction (i.e., electrolyzing water and producing hydrogen). Suitable catalyst include, but are not limited to, materials comprising platinum, palladium, rhodium, carbon, gold, tantalum, tungsten, ruthenium, iridium, osmium, alloys of at least one of the foregoing catalysts, and the like. Electrodes 210 and 215 can be formed on membrane 220, or may be layered adjacent to, but in contact with, membrane 220.

In an embodiment, flow field member 240 includes a screen pack or bipolar plate 242 in combination with a porous plate support member 244, with the porous plate 244 being adjacent the MEA 205. A screen or bipolar plate 242 and porous plate 244, capable of supporting membrane 220, allowing the passage of system fluids, and preferably conducting electrical current, is desirable. In an embodiment, the screens may comprise layers of perforated sheets or a woven mesh formed from metal or strands. These screens are typically comprised of metals, such as, for example, niobium, zirconium, tantalum, titanium, carbon steel, stainless steel, nickel, cobalt, and alloys comprising at least one of the foregoing metals. The geometry of the openings in the screens can range from ovals, circles, and hexagons to diamonds and other elongated shapes. Bipolar plates are commonly porous structures comprising fibrous carbon or fibrous carbon impregnated with polytetrafluoroethylene or PTFE (commercially available under the trade name TEFLON® from E. I. du Pont de Nemours and Company). However, the bipolar plates are not limited to carbon or PTFE impregnated carbon, they may also be made of any of the foregoing materials used for the screens, such as niobium, zirconium, tantalum, titanium, carbon steel, stainless steel, nickel, cobalt, and associated alloys, for example.

With reference now to FIG. 3, cell separator plate 245 and MEA 205 define the flow field 225 that extends from MEA 205 to cell separator plate 245. In an embodiment, flow field member 235 on the hydrogen side of MEA 205 is composed of a MEA support member 300 and a MEA support member stiffener 310.

Support member 300 may be a single layer or a plurality of layers of a porous material suitable for the purposes disclosed herein, such as a porous metallic plate, a metallic screen, a pad of metallic strands, a carbon paper, a cloth of random carbon fiber, a woven cloth of carbon strands, a woven cloth of multi-strand carbon, any other porous and electrically conductive material capable of sustaining a compressible pressure of equal to or greater than 50 pounds-per-square-inch (psi) and being non-oxidizing in a hydrogen or oxygen rich environment, or any combination of the foregoing, for example. A suitable metal for support member 300 may be niobium, zirconium, tantalum, titanium, carbon steel, stainless steel, nickel, cobalt, and alloys comprising at least one of the foregoing, for example. A suitable non-metal for support member 300 may be TGP-H-120 carbon fiber paper available from Toray Industries, for example.

Support member stiffener (stiffener) 310 may be a single layer or a plurality of layers of a porous material suitable for the purposes disclosed herein, such as a porous metallic plate, and etched metallic plate having flow channels, a metallic screen, a perforated metallic plate, any other electrically conductive material configured to allow three-dimensional fluid flow within flow field 225, or any combination of the foregoing, for example.

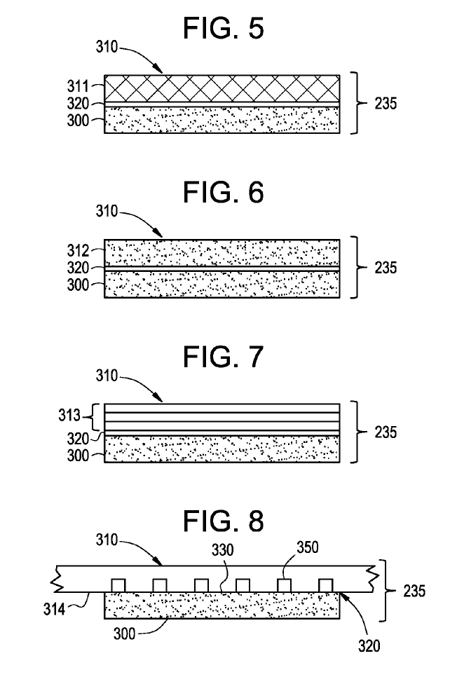

Alternative embodiments of support member 300 and stiffener 310 will be discussed in more detail below with reference to FIGS. 5-8.

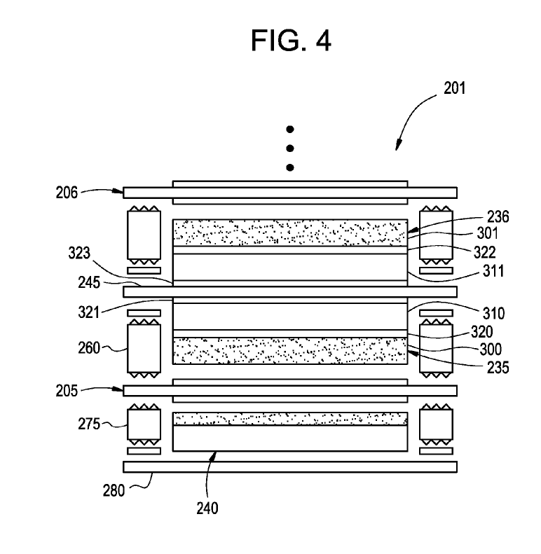

To enhance the stiffness attribute of support member 300, stiffener 310 may be mechanically and electrically bonded to cell separator plate 245 and/or support member 300, which is illustrated generally by bond regions 321 and 320, respectively, in FIG. 4. In an embodiment, the bonding may be accomplished by diffusion bonding, sintering, soldering, brazing, bonding via electrically conductive adhesive, or any combination of the foregoing. By utilizing a bonded assembly for flow field member 235, cell separator plate 245, support member 300 and stiffener 310 may be employed in cell 200 in the absence of metallic plating on the contacting (adjoining) surfaces of the cell separator plate 245, the support member 300 and the stiffener 310.

In FIG. 3, support member 300 is bonded to stiffener 310, which is disposed proximate to but not necessarily bonded to separator plate 245. However, in an alternative embodiment, and with reference now to FIG. 4, stiffener 310 may also be bonded to separator plate 245 via bond region 321.

FIG. 4 also depicts another flow field member 236 on the opposite side of separator plate 245 to that of flow field member 235. While FIG. 4 depicts both bond regions 321 and 323 bonding flow field members 235 and 236, respectively, to separator plate 245, it will be appreciated that only one bond region or both bond regions may be employed.

In an exemplary embodiment, cell 201 of FIG. 4 (similar to that of cell 200 of FIG. 3 but depicted having a plurality of MEA's 205, 206) includes cell separator plate 245 with flow field member 235 bonded to one side via bond region 321, and with flow field member 236 bonded to the other side via bond region 323, thereby utilizing the stiffness of separator plate 245 for the purpose of stiffening two support members 300, 301. As depicted, the respective stiffener 310, 311 is adjacent the cell separator plate 245, and the respective support member 300, 301 is adjacent the respective MEA 205, 206.

In an alternative embodiment, stiffeners 310 and 311 may be bonded to separator plate 245 via respective bond regions 321, 323, but support members 300 and 301 may not be bonded to respective stiffeners 310, 311. Thus, while FIG. 4 depicts all four bond regions 320, 321, 322 and 323, FIG. 4 is intended to convey that alternative embodiments having the presence or absence of any combination of bond regions 320, 321, 322 and 323 is contemplated for the purpose disclosed herein.

Each flow field member 235, 236 may be identical to or different from each other (oriented as discussed above), with alternative embodiments being illustrated in FIGS. 5-8. Referring now to FIGS. 5-8, alternative embodiments of bonded flow field members 235, 236 are depicted, keeping in mind that either or both flow field members 235, 236 may be bonded to separator plate 245.

In FIG. 5, flow field member 235 is composed of a porous support member 300 bonded 320 to a screen pack stiffener 311.

In FIG. 6, flow field member 235 is composed of a porous support member 300 bonded 320 to a second porous support member 312 serving as stiffener 310. In an embodiment where stiffener 310 is composed of a second porous support member, stiffener 310 may be a porous metallic plate, a metallic screen, or any other porous and electrically conductive metallic material capable of sustaining a compressible pressure of equal to or greater than 50 pounds-per-square-inch (psi). In FIG. 7, flow field member 235 is composed of a porous support member 300 bonded 320 to a plurality of porous or perforated layers 313 configured to allow for three-dimensional fluid flow within flow field 225.

In FIG. 8, where multiple cells 200 may be employed, flow field member 235 is depicted being composed of a porous support member 300 bonded 320 to the ridges 330 of a bipolar plate 314. As illustrated in FIGS. 5-8, the MEA support member stiffener is represented generally by reference numeral 310 and more specifically by reference numerals 311, 312, 313 and 314. However, while specific alternative embodiments are illustrated for stiffener 310, it will be appreciated that this is for illustration purposes only, and that other embodiments of stiffener 310 may be employed and still fall within the scope of the invention disclosed herein.

In an embodiment where stiffener 310 is composed of a plurality of layers 313, such as that depicted in FIG. 7, the layers 313 are mechanically and electrically bonded together. In an embodiment, the bonding may be accomplished by diffusion bonding, sintering, soldering, brazing, bonding via electrically conductive adhesive, or any combination of the foregoing.

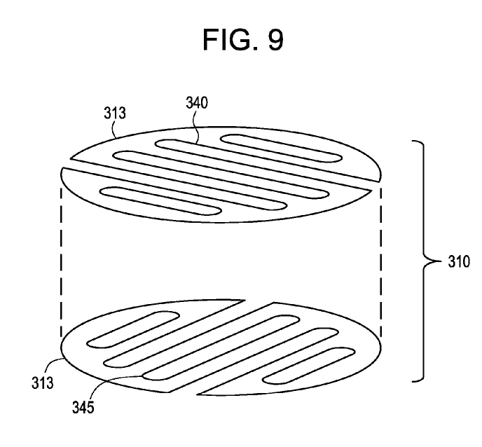

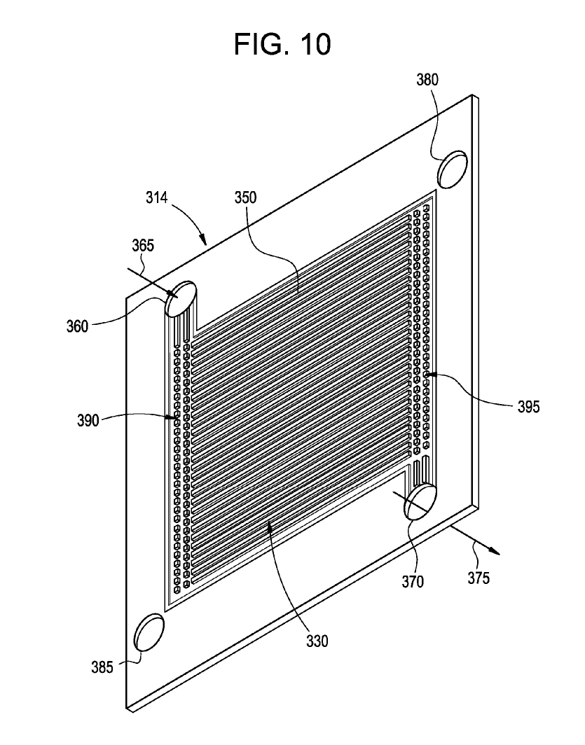

Referring now to FIG. 9, an exemplary embodiment of stiffener 310 composed of perforated layers 313 is depicted. Here, layers 313 have through-cut perforations 340, 345, where some perforations, 340 for example, may extend to an edge of the layer 313. By orienting the perforations of adjacent layers 313 at different angles relative to each other, as depicted in the exploded assembly view of FIG. 9, three-dimensional fluid flow across the stiffener 310 may be achieved. While only two layers 313 are depicted in FIG. 9, it will be appreciated that this is for illustration purposes only and that embodiments of the invention are not limited to only two layers 313. In an alternative embodiment, through-cut perforations 340, 345 may be replaced with embossed profiles or etched grooves (not shown) for providing flow channels having the function of perforations 340, 345. As discussed previously, multiple cells 200 may be stacked together to provide increased output. In such an arrangement, a bipolar plate 314 may be employed in place of cell separator plate 245, which will now be discussed with reference to FIGS. 8 and 10 collectively.

In FIG. 10, one side of a bipolar plate 314 is depicted having ridges 330 formed in a surface thereof for defining flow channels 350 thereat (also depicted in FIG. 8). A first inlet port 360 for receiving a first flow path 365, and a first outlet port 370 for receiving a second flow path 375, are in fluid communication with first and second header channels 390, 395 that provide for flow distribution between ports 360, 370 and flow channels 350. The other side (not shown) of bipolar plate 314 is similarly configured to the first side, but for flow between second inlet port 380 and second outlet port 385, which cooperate in a similar manner with flow paths (not shown) on the other side of bipolar plate 314.

As depicted in FIG. 8 and discussed above in connection therewith, one or more of the outer surfaces of the ridges 330 are bonded to the support member 300. In an embodiment, the bonding may be accomplished by diffusion bonding, sintering, soldering, brazing, bonding via electrically conductive adhesive, or any combination of the foregoing.

By mechanically bonding support member 300 to the ridges 330 of bipolar plate 314, and more generally, by mechanically bonding support member 300 to the non-porous outer surface regions of stiffener 310, it will be appreciated that a rigidly supported beam arrangement of support member 300 between the bonded regions is achieved, thereby resulting in a support member (layer or plurality of layers) 300 that is restrained from deflecting both toward the MEA and away from the MEA at an operational pressure of equal to or greater than 50 psi, more so than it would be if the support member 300 was not bonded and was merely simply supported. In view of the foregoing described and illustrated structure, it will be appreciated that other embodiments of the invention include a method of stiffening a support member 300 for a MEA 205 of an electrochemical cell 200, the cell 200 having a cell separator plate 245 disposed on a side of the MEA 205 and defining a flow field 225 therebetween. In an exemplary method, a porous and electrically conductive MEA support member (layer or plurality of layers) 300 is made available for assembly within the cell 200, the support member 300 being configured for disposition adjacent the MEA 205 within the flow field 225. Also, a porous and electrically conductive MEA support member stiffener 310 is made available for assembly within the cell 200, the stiffener 310 being configured for disposition adjacent the support member 300 on a side opposite that of the MEA 205. Prior to assembly within the cell 200, the stiffener 310 is mechanically and electrically bonded to the cell separator plate 245 and/or the support member 300. Where bonded to the support member 300, the bonding is such that the support member 300 is restrained from deflecting both toward the MEA 205 and away from the MEA 205 at an operational pressure of equal to or greater than 50 psi.

By employing a bonded arrangement of stiffener 310, cell separator plate 245 and/or support member 300, as herein disclosed, instead of an unbonded arrangement, it is contemplated that the unexpected advantage of reduced deformation of the support member 300, and therefore enhanced operational characteristics of cell 200 (such as less creep, less change in resistance, less change in power output, for example) will be achieved.

While embodiments of the invention have been described herein with particular reference to flow field member 235 on one side of separator plate 245, it will be appreciated that alternative embodiments may apply the teachings disclosed herein to flow field member 236 on the other side of separator plate 245.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode or only mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. An electrochemical cell comprising:
a membrane-electrode-assembly (MEA);
a cell separator plate disposed on a side of the MEA and defining a flow field therebetween;
a MEA support layer disposed adjacent the MEA within the flow field, the support layer being porous and electrically conductive; and
a MEA support layer stiffener disposed adjacent the support layer on a side opposite that of the MEA, the stiffener being porous and electrically conductive;
wherein the stiffener is mechanically and electrically bonded to the cell separator plate.

2. The electrochemical cell of claim 1, wherein:
the stiffener and cell separator plate are diffusion bonded, sintered, soldered, brazed, bonded via electrically conductive adhesive, or bonded by a combination comprising at least one of the foregoing.

3. The electrochemical cell of claim 1, wherein:
the bonded stiffener and cell separator plate are absent metallic plating on their adjoining surfaces.

4. The electrochemical cell of claim 1, wherein:
the stiffener comprises a plurality of perforated layers configured to allow three-dimensional fluid flow, the plurality of perforated layers being mechanically and electrically bonded together.

5. The electrochemical cell of claim 4, wherein:
each of the perforated layers include one or more perforations that extend to an edge of the respective layer.

6. The electrochemical cell of claim 1, wherein:
the support layer comprises a porous metallic plate, a metallic screen, a carbon paper, a cloth of random carbon fiber, a woven cloth of carbon strands, a woven cloth of multi-strand carbon, any other porous and electrically conductive material capable of sustaining a compressible pressure of equal to or greater than 50 pounds-per-square-inch (psi) or any combination comprising at least one of the foregoing.

7. The electrochemical cell of claim 6, wherein:
the stiffener comprises a plurality of perforated layers configured to allow three-dimensional fluid flow, the plurality of perforated layers being mechanically and electrically bonded together.

8. The electrochemical cell of claim 6, wherein:
the stiffener comprises a second of a porous metallic plate, a metallic screen, or any other porous and electrically conductive metallic material capable of sustaining a compressible pressure of equal to or greater than 50 pounds-per-square-inch (psi).

9. The electrochemical cell of claim 6, wherein:
a bipolar plate serves as both the stiffener and the cell separator plate, the bipolar plate having ridges that define flow channels at a surface thereof, one or more of the outer surfaces of the ridges being bonded to the support layer.

10. The electrochemical cell of claim 1, wherein:
the stiffener is mechanically and electrically bonded to the support layer such that the support layer is restrained from deflecting both toward the MEA and away from the MEA at an operational pressure of equal to or greater than 50 psi.

11. The electrochemical cell of claim 10, wherein:
the stiffener and support layer are diffusion bonded, sintered, soldered, brazed, bonded via electrically conductive adhesive, or bonded by a combination comprising at least one of the foregoing.

12. The electrochemical cell of claim 11, wherein:
the bonded stiffener and support layer are absent metallic plating on their adjacent faces.

13. The electrochemical cell of claim 1, wherein the stiffener defines a first stiffener on one side of the cell separator plate, and further comprising:
a second MEA support layer stiffener disposed on the opposite side of the cell separator plate and being mechanically and electrically bonded thereto.

14. The electrochemical cell of claim 13, wherein the second stiffener comprises a plurality of perforated layers mechanically and electrically bonded together and configured to allow three-dimensional fluid flow therethrough.

15. A method of stiffening a support layer for a membrane-electrode-assembly (MEA) of an electrochemical cell, the method comprising:
making available for assembly within the cell a cell separator plate, the cell separator plate being configured for disposition on a side of the MEA to define a flow field therebetween;
making available for assembly within the cell a porous and electrically conductive MEA support layer, the support layer being configured for disposition adjacent the MEA within the flow field;
making available for assembly within the cell a porous and electrically conductive MEA support layer stiffener, the stiffener being configured for disposition adjacent the support layer on a side opposite that of the MEA; and
mechanically and electrically bonding the stiffener to the cell separator plate.

16. The method of claim 15, further comprising:
mechanically and electrically bonding the stiffener to the support layer such that the support layer is restrained from deflecting both toward the MEA and away from the MEA at an operational pressure of equal to or greater than 50 psi.

17. The method of claim 16, wherein the bonding the stiffener to the cell separator plate and/or the bonding the stiffener to the support layer comprises:
diffusion bonding, sintering, soldering, brazing, bonding via electrically conductive adhesive, or any combination comprising at least one of the foregoing.

18. The method of claim 16, wherein the bonding the stiffener to the cell separator plate and/or the bonding the stiffener to the support layer comprises:
bonding in the absence of metallic plating on the respective adjoining surfaces.

19. An electrochemical cell comprising:
a membrane-electrode-assembly (MEA);
a cell separator plate disposed on a side of the MEA and defining a flow field therebetween;
a MEA support layer disposed adjacent the MEA within the flow field, the support layer being porous and electrically conductive; and
a MEA support layer stiffener disposed adjacent the support layer on a side opposite that of the MEA, the stiffener comprising a plurality of perforated electrically conductive layers configured to allow three-dimensional fluid flow, the plurality of perforated layers being mechanically and electrically bonded together;
wherein the stiffener is mechanically and electrically bonded to the cell separator plate, the bonded stiffener and cell separator plate being absent metallic plating on their adjoining surfaces.

20. The electrochemical cell of claim 19, wherein:
the stiffener is mechanically and electrically bonded to the support layer, the bonded stiffener and support layer being absent metallic plating on their adjoining surfaces.
